(19) United States
(12) Patent Application Publication
(10) Pub. No.: US 2020/0158507 A1
(43) Pub. Date: May 21, 2020

(54) POINT OF INTEREST BASED VEHICLE SETTINGS

(71) Applicant: GM GLOBAL TECHNOLOGY OPERATIONS LLC, Detroit, MI (US)

(72) Inventors: David T. De Carteret, Fenton, MI (US); Adam D. Stanton, White Lake, MI (US)

(73) Assignee: GM GLOBAL TECHNOLOGY OPERATIONS LLC, Detroit, MI (US)

(21) Appl. No.: 16/194,942

(22) Filed: Nov. 19, 2018

(51) Int. Cl. G01C 21/20; G06F 16/28; G06F 16/9537

(52) U.S. Cl. CPC G01C 21/20; G06F 16/9537; G06F 16/285

(57) ABSTRACT

In accordance with certain embodiments, a vehicle is provided that includes a location system, an operation system, and a processor. The location system is configured to obtain location data pertaining to the vehicle. The operation system is configured to provide a feature for operation of the vehicle. The processor is coupled to the location system and the operation system, and is configured to: identify a point of interest in proximity to the vehicle based on the location data; determine a category to which the point of interest belongs; and provide instructions for the operation system to initiate a setting for the feature for operation of the vehicle based on the category for the point of interest that is in proximity to the vehicle and a history of the vehicle.

### TECHNICAL FIELD

The technical field generally relates to vehicles and, more specifically, to methods and systems for controlling vehicle functionality based on the vehicle's proximity to a point of interest.

Many vehicles include navigation systems to determine a vehicle's location. However, in certain situations, it may be desirable to further utilize the location information to provide enhancements for the vehicle.

Accordingly, it is desirable to provide improved methods and systems for providing certain features or enhancements for the vehicle utilizing location information for the vehicle. Furthermore, other desirable features and characteristics of the present invention will become apparent from the subsequent detailed description of the invention and the appended claims, taken in conjunction with the accompanying drawings and this background of the invention.

### SUMMARY

In one exemplary embodiment, a method is provided. The method includes: identifying a point of interest in proximity to a vehicle based on location data for the vehicle; determining a category to which the point of interest belongs; and initiating, via instructions provided by a processor, a setting for a feature for operation of the vehicle based on the category for the point of interest that is in proximity to the vehicle and a history of the vehicle.

Also in one embodiment, the step of initiating the setting includes initiating a pre-set value for ride height of the vehicle, based on the category for the point of interest that is in proximity to the vehicle and the history of the vehicle.

Also in one embodiment, the step of initiating the setting includes initiating a pre-set value for a performing mode of the vehicle, based on the category for the point of interest that is in proximity to the vehicle and the history of the vehicle.

Also in one embodiment, the category includes a type of terrain associated with the point of interest that is in proximity to the vehicle.

Also in one embodiment, the category includes a type of service provided at the point of interest that is in proximity to the vehicle.

Also in one embodiment, the method further includes: identifying an action for the vehicle while the vehicle is in proximity to the point of interest, based on vehicle data; and storing, in memory, a pre-set value for the feature for the category for the point of interest that is in proximity to the vehicle, based on the identified action.

Also in one embodiment, the method further includes receiving an input from a user of the vehicle as to whether the action should be replicated when the vehicle is in proximity to similar points of interest at future times; and the pre-set value is stored in the memory for the setting for the feature for the category for the point of interest that is proximity to the vehicle, based on the identified action, upon a further condition that the input from the user provides that the action should be replicated when the vehicle is in proximity to similar points of interest at future times.

Also in one embodiment, the vehicle data pertains to an operator command for a vehicle system associated with the action.

Also in one embodiment, the vehicle data pertains to sensor data for operation of a vehicle system associated with the action.

Also in one embodiment, the method further includes determining whether the category of the point of interest that is in proximity to the vehicle has a pre-set value stored in a memory of the vehicle for the feature; and the step of initiating the setting includes initiating, via instructions provided by the processor, the pre-set value for the feature when the pre-set value is stored in the memory.

In another exemplary embodiment, a system is provided. The system includes a data module and a processing module. The data module is configured to obtain location data pertaining to a vehicle. The processing module is coupled to the data module, and is configured to, using a processor: identify a point of interest in proximity to the vehicle based on the location data; determine a category to which the point of interest belongs; and provide instructions to initiate a setting for a feature for operation of the vehicle based on the category for the point of interest that is in proximity to the vehicle and a history of the vehicle.

Also in one embodiment, the data module is further configured to obtain vehicle data for the vehicle; and the processing module is configured to: identify an action for the vehicle while the vehicle is in proximity to the point of interest, based on the vehicle data; and store, in memory, a pre-set value for the feature for the category for the point of interest that is in proximity to the vehicle, based on the identified action.

Also in one embodiment, the data module is further configured to receive an input from a user of the vehicle as to whether the action should be replicated when the vehicle is in proximity to similar points of interest at future times; and the processing module is configured to store the pre-set value in the memory for the setting for the feature for the category for the point of interest that is proximity to the vehicle, based on the identified action, upon a further condition that the input from the user provides that the action should be replicated when the vehicle is in proximity to similar points of interest at future times.

Also in one embodiment, the processing module is further configured to: determine whether the category of the point of interest that is in proximity to the vehicle has a pre-set value stored in a memory of the vehicle for the feature; and initiate, via instructions provided by the processor, the pre-set value for the feature when the pre-set value is stored in the memory.

In another exemplary embodiment, a vehicle is provided. The vehicle includes a location system, an operation system, and a processor. The location system is configured to obtain location data pertaining to the vehicle. The operation system is configured to provide a feature for operation of the vehicle. The processor is coupled to the location system and the operation system, and is configured to: identify a point of interest in proximity to the vehicle based on the location data; determine a category to which the point of interest belongs; and provide instructions for the operation system to initiate a setting for the feature for operation of the vehicle based on the category for the point of interest that is in proximity to the vehicle and a history of the vehicle.

Also in one embodiment, the processor is configured to provide instructions for the operation system to initiate a pre-set value for a ride height of the vehicle, based on the category for the point of interest that is in proximity to the vehicle and the history of the vehicle.

Also in one embodiment, the processor is configured to provide instructions for the operation system to initiate a pre-set value for a performing mode of the vehicle, based on the category for the point of interest that is in proximity to the vehicle and the history of the vehicle.

Also in one embodiment, the vehicle further includes a memory; and the processor is configured to: identify an action for the vehicle while the vehicle is in proximity to the point of interest, based on vehicle data; and store, in the memory, a pre-set value for the setting for the feature for the category for the point of interest that is in proximity to the vehicle, based on the identified action.

Also in one embodiment, the vehicle further includes a sensor that is configured to receive an input from a user of the vehicle as to whether the action should be replicated when the vehicle is in proximity to similar points of interest at future times; and the processor is configured to store the pre-set value in the memory for the setting for the feature for the category for the point of interest that is proximity to the vehicle, based on the identified action, upon a further condition that the input from the user provides that the action should be replicated when the vehicle is in proximity to similar points of interest at future times.

Also in one embodiment, the vehicle further includes a memory; and the processor is configured to: determine whether the category of the point of interest that is in proximity to the vehicle has a pre-set value stored in the memory for the feature; and provide instructions to the operation system to initiate the pre-set value for the feature when the pre-set value is stored in the memory.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for controlling one or more settings for operational features of the vehicle based on a category associated with a point of interest that is in proximity to the vehicle and a prior history for the vehicle, in accordance with exemplary embodiments;

FIG. 2 is a block diagram of modules of the control system of FIG. 1, in accordance with exemplary embodiments; and

FIG. 3 is a flowchart of a process for controlling one or more settings for operational features of the vehicle based on a category associated with a point of interest that is in proximity to the vehicle and a prior history for the vehicle, in accordance with exemplary embodiments, and that can be implemented in connection with the vehicle and control system of FIGS. 1 and 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

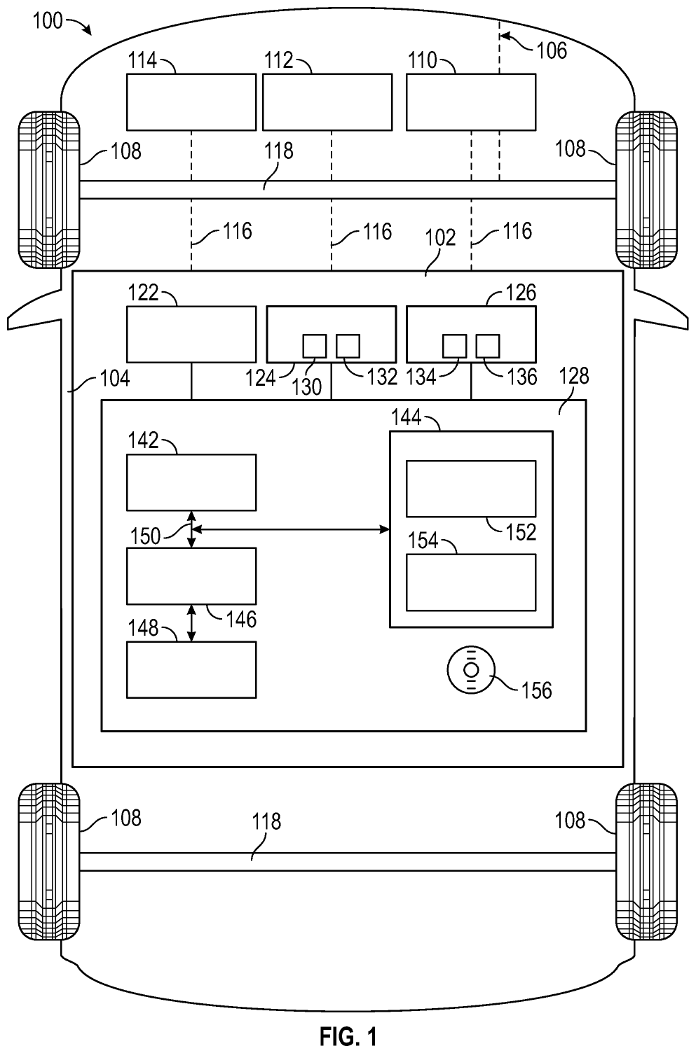

FIG. 1 illustrates a vehicle 100, according to an exemplary embodiment. As described in greater detail further below, the vehicle 100 includes a control system 102 for controlling settings for operational features of the vehicle 100 based on a category associated with a point of interest that is in proximity to the vehicle 100 and a prior history for the vehicle 100.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments.

The vehicle 100 includes a body 104 that is arranged on a chassis 106. The body 104 substantially encloses other components of the vehicle 100. The body 104 and the chassis 106 may jointly form a frame. The vehicle 100 also includes a plurality of wheels 108. The wheels 108 are each rotationally coupled to the chassis 106 near a respective corner of the body 104 to facilitate movement of the vehicle 100. In one embodiment, the vehicle 100 includes four wheels 108, although this may vary in other embodiments (for example for trucks and certain other vehicles).

A drive system 110 is mounted on the chassis 106, and drives the wheels 108, for example via axles 118. The drive system 110 preferably comprises a propulsion system. In certain exemplary embodiments, the drive system 110 comprises an internal combustion engine and/or an electric motor/generator, coupled with a transmission thereof. In certain embodiments, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In various embodiments, a location system 112 obtains data pertaining to a geographic location for the vehicle 100. In certain embodiments, the location system 112 comprises one or more satellite-based systems for determining the geographic location, heading, and related data for the vehicle 100, for example including a navigation system, global positioning system (GPS), or the like, and/or components thereof, for the vehicle 100.

In various embodiments, one or more operational systems 114 control various operational features for the vehicle 100. In certain embodiments, the operational systems 114 may be part of and/or coupled to the drive system 110. In certain other embodiments, the operational systems 114 may be separate from the drive system 110. In various embodiments, the operational systems 114 control and/or implement various features for the vehicle 100 that each have a plurality of settings for different conditions encountered by the vehicle 100, for example including settings for an adjustable ride height for the vehicle 100 and/or settings for one or more performing modes for the vehicle 100 (e.g., a tour mode versus a sport mode, a performing mode versus a quiet mode, a standard mode versus an off road, and so on), with changes in the settings affecting steering, stability control, braking, suspension, shock absorbers, exhaust control, noise control, and so on pertaining to the different features. In various embodiments, the settings for such features of the operational systems 114 are implemented by the operational systems 114 in accordance with instructions provided thereto by the control system 102.

In various embodiments, one or more communication links 116 are utilized to couple the drive system 110, location system 112, and operational systems 114 to the control system 102. In certain embodiments, the communication link(s) 116 also couple to the drive system, the location system 112, and/or the operational system 114 to one another. In certain embodiments, the communication link(s) 116 comprise a vehicle CAN bus. In certain other embodiments, the communication link(s) 116 comprise one or more transceivers, and/or one or more other types of communication links.

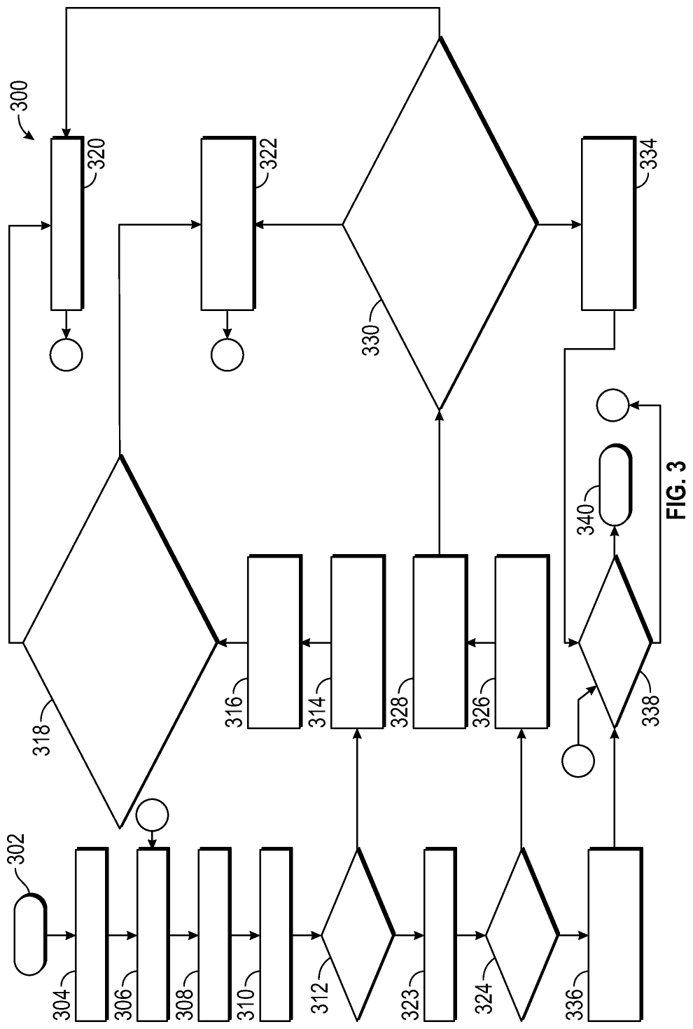

In various embodiments, the control system 102 is coupled to the drive system 110, the location system 112, and the operational systems 114 via the communication links(s) 116. Also in various embodiments, the control system 102 receives location data from the location system 112, and provides instructions for operation of the drive system 110 and the operational system 114 using the location data. In various embodiments, the control system 102 controls one or more settings for operational features of the operational systems 114 based on a category associated with a point of interest that is in proximity to the vehicle and a prior history for the vehicle. In certain embodiments, the control system 102 provides these functions in accordance with the process 300 described in greater detail further below in connection with FIG. 3.

In various embodiments, the control system 102 is disposed within the body 104 of the vehicle 100. In one embodiment, the control system 102 is mounted on the chassis 106. In certain embodiments, the control system 102 and/or one or more components thereof may be disposed outside the body 104, for example on a remote server or in the cloud.

As depicted in FIG. 1, in certain embodiments, the control system 102 includes a communication device 122, a display 124, a sensor array 126, and a controller 128. As noted above, in various embodiments, the control system 102. In various embodiments, the communication device 122 receives location data from the location system 112 and/or vehicle data (e.g., regarding operation of the vehicle 100) from the drive system 110 and/or operational systems 114. In certain embodiments, the vehicle data includes user commands and/or settings as to various features for the vehicle 100 (e.g., a user's command for ridge height, steering, stability control, braking, performing modes, and so on for the vehicle 100). Also in certain embodiments, the control system 102 provides instructions to the drive system 110 and/or operational systems 114 via the communication device 122 (e.g., as to implementing settings for operational features for the vehicle 100). In certain embodiments, the communication device 122 comprises a transceiver for communications between the control system 102 and the drive system 110, location system 112, and operational systems 114. In certain other embodiments, communications may be performed between the control system 102 and the drive system 110, location system 112, and operational systems 114 via a wired connection for the communication link(s) 116, for example via a vehicle CAN bus.

In various embodiments, the display 124 provides information for an operator of the vehicle 100 as to available settings for various operational features for the vehicle 100, such as those referenced above in connection with the operational systems 114. Also in various embodiments, the display 124 allows a user of the vehicle to provide preferences or inputs via the display 124. In various embodiments, the display 124 may include an audio component 130, a visual component 132, or both.

In various embodiments, the sensor array 126 provides sensor data to the controller 128. In various embodiments, the sensor array 126 includes one or more input sensors 134 that are configured the receive inputs from a user of the vehicle as to the user's preferences for implementing various settings for the operational features for the vehicle 100, including for automatic adjustment of settings when the vehicle 100 is in proximity to a point of interest that belongs to a particular category. For example, in certain embodiments, such input sensors 134 may include a microphone of or coupled to the audio component 130 and/or a touch sensor of or coupled to the visual component 132 of the display 124, or the like.

Also in various embodiments, the sensor array 126 further includes one or more vehicle sensors 136 to collect vehicle data as to operation of the vehicle 100, for example including operational actions for the vehicle in implementing one or more settings for the operational features of the vehicle 100. For example, in certain embodiments, such vehicle sensors 136 may comprise one or more brake pedal sensors, steering angle sensors, accelerometers, or the like. In various embodiments, the sensor array 126 provides the sensor data to the controller 128 via the communication link 116, such as a vehicle CAN bus. In certain other embodiments, the sensor data may be provided via the communication device 122 (e.g., a transceiver).

The controller 128 controls operation of the control system 102. Specifically, in various embodiments, the controller 128 controls one or more settings for operational features of the operational systems 114 based on a category associated with a point of interest that is in proximity to the vehicle and a prior history for the vehicle 100. In various embodiments, the controller 128 provides these and other functions in accordance with the steps of the process 300 discussed further below in connection with FIG. 3.

In one embodiment, the controller 128 is coupled to the communication device 122, the display 124, and the sensor array 126. In certain embodiments, the controller 128 (and/or components thereof, such as the processor 142 and/or other components) may be part of and/or disposed one or more other vehicle components. In addition, in certain embodiments, the controller 128 may be placed outside the vehicle, such as in a remote server, in the cloud or on a remote smart device.

As depicted in FIG. 1, the controller 128 comprises a computer system. In certain embodiments, the controller 128 may also include the communication device 122, the display 124, the sensor array 126 and/or one or more other vehicle components. In addition, it will be appreciated that the controller 128 may otherwise differ from the embodiment depicted in FIG. 1. For example, the controller 128 may be coupled to or may otherwise utilize one or more remote computer systems and/or other control systems, for example as part of one or more of the above-identified vehicle devices and systems.

In the depicted embodiment, the computer system of the controller 128 includes a processor 142, a memory 144, an interface 146, a storage device 148, and a bus 150. The processor 142 performs the computation and control functions of the controller 128, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 128 and the computer system of the controller 128, generally in executing the processes described herein, such as the process 300 discussed further below in connection with FIG. 3.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with one or more stored values 154 (e.g., including, in various embodiments, stored values relating prior vehicle actions with particular categories of points of interest in proximity to the vehicle 100).

The bus 150 serves to transmit programs, data, status and other information or signals between the various components of the computer system of the controller 128. The interface 146 allows communications to the computer system of the controller 128, for example from a system driver and/or another computer system, and can be implemented using any suitable method and apparatus. In one embodiment, the interface 146 obtains the various data from the drive system 110, operational vehicle systems 114, the communication device 122, the display 124, and/or the sensor array 126. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 300 discussed further below in connection with FIG. 3. In another exemplary embodiment, the program product may be directly stored in and/or otherwise accessed by the memory 144 and/or a disk (e.g., disk 156), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 128 may also otherwise differ from the embodiment depicted in FIG. 1, for example in that the computer system of the controller 128 may be coupled to or may otherwise utilize one or more remote computer systems and/or other control systems.

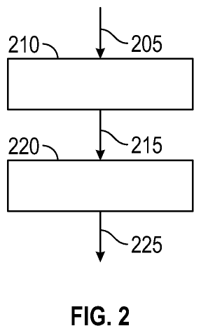

FIG. 2 provides a functional block diagram for modules of the control system 102 of FIG. 1, in accordance with exemplary embodiments. In various embodiments, each module includes and/or utilizes computer hardware, for example via one or more computer processors and memory. As depicted in FIG. 2, in various embodiments, the control system 102 generally includes a data module 210 and a processing module 220. In various embodiments, the data module 210 and processing module 220 are disposed onboard the vehicle 100. As can be appreciated, in certain embodiments, parts of the control system 102 may be disposed on a system remote from the vehicle 100 while other parts of the control system 102 may be disposed on the vehicle 100.

In various embodiments, the data module 210 obtains location data from the location system 112 as to a geographic location of the vehicle 100 and proximity to a point of interest. In various embodiments, the data module 210 also obtains vehicle data from the operational systems 114 and/or the vehicle sensors 136 of the sensor array 126 as to vehicle actions (including settings for particular operational features of the vehicle 100) that are undertaken when the vehicle 100 is in proximity to a point of interest. In addition, in various embodiments, the data module 210 also obtains inputs from a user of the vehicle 100 via one or more input sensors 134 of FIG. 1 as to the user's preferences as to whether to implement similar vehicle settings in the future when the vehicle 100 encounters similar types of points of interest (i.e., belonging to the same point of interest category). In various embodiments, the data module 210 obtains the data as inputs 205, as shown in FIG. 2.

Also in various embodiments, the data module 210 provides information pertaining to the data (including the proximity of the vehicle 100 to a point of interest, along with vehicle data regarding vehicle actions and user inputs as to setting preferences) as outputs 215 for use by the processing module 220, for example as discussed below.

In various embodiments, the processing module 220 utilizes the data as inputs 215 for the processing module 220, and controls one or more settings for operational features of the operational systems 114 based on the data. Specifically, in various embodiments, the processing module: (i) determines a category associated with a point of interest that is in proximity to the vehicle 100, using the location data; (ii) identifies a vehicle action using the vehicle data; (iii) stores, in memory, a pre-set value for the setting based on the vehicle action and the user input, for use when the vehicle 100 is in proximity to points of interest of the same category in the future; (iv) determines the pre-set value when the vehicle 100 is in proximity to such points of interest of the same category; and (v) provides instructions for the initiation of a setting of one or more operational features of the vehicle 100 based on the pre-set value, for example in accordance with the process 300 described below in connection with FIG. 3. In certain embodiments, such instructions are provided by the processing module 220 as outputs 225 depicted in FIG. 2 to a module associated with the drive system 110 and/or the operational systems 114 of FIG. 1.

FIG. 3 is a flowchart of a process 300 for controlling settings for operational features of the vehicle based on a category associated with a point of interest that is in proximity to the vehicle and a prior history for the vehicle, in accordance with exemplary embodiments. The process 300 can be implemented in connection with the vehicle 100 and control system 102 of FIGS. 1 and 2, in accordance with exemplary embodiments.

As depicted in FIG. 3, the process begins at 302. In one embodiment, the process 300 begins when a vehicle drive or ignition cycle begins, for example when a driver approaches or enters the vehicle 100, or when the driver closes the driver door of the vehicle when entering the vehicle, or when the driver turns on the vehicle and/or an ignition therefor (e.g. by turning a key, engaging a keyfob or start button, and so on). Also in certain embodiments, the functionality of controlling vehicle settings based on point of interest categories is enabled at 304 as the process begins (e.g., in certain embodiments, by a user input). In one embodiment, the steps of the process 300 are performed continuously during operation of the vehicle.

In various embodiments, vehicle data is obtained at 306. In certain embodiments, the vehicle data pertains to operation of the drive system 110 and the operational systems 114 of FIG. 1. For example, in various embodiments, the vehicle data pertains to user instructions for controlling the operational systems 114 and/or the drive system 110 and/or sensor data obtained via the vehicle sensors 136 from the sensor array 126 pertaining to various vehicle operating parameters, such as steering angle, braking force and/or position, velocity, acceleration, position, and/or various other parameters, such as those pertaining to stability control, suspension, shock absorbers, exhaust control, noise control, and and/or various other parameters pertaining to various vehicle operating features. In certain embodiments, the vehicle data is obtained via the data module 210 of FIG. 2. In various embodiments, the vehicle data is provided by the sensor array 126, the drive system 110, and/or the operational systems 114 of FIG. 1 to the processor 142 of FIG. 1 for processing.

Also in various embodiments, location data is obtained at 308. In certain embodiments, location data pertains to a particular geographic location for the vehicle 100. In various embodiments, the location data is obtained via the location system 112 of FIG. 1 and provided to the processor 142 of FIG. 1 for processing.

A location of the vehicle is identified at 310. In certain embodiments, a specific geographic location (e.g., with latitude and longitude components) is identified by the processor 142 of FIG. 1 based on the location data of 308, via the processing module 220 of FIG. 2, and/or is provided to the processor 142 as part of the location data.

A determination is made at 312 as to whether a point of interest is in proximity to the vehicle. In various embodiments, as used herein, the term “point of interest” refers to any type of specific point location (or location in general) that a user of the vehicle 100 may find useful or interesting, such as, by way of example, a service station, a store, a restaurant, a scenic lookout, a tourist destination, a campground, a hotel, a residential neighborhood, a school, a hospital, and/or any number of other types of points of interest. In certain embodiments, the determination of step 312 is whether a categorizable point of interest (i.e., a point of interest that can be readily placed into a point of interest category). In certain embodiments, this determination is made by the processor 142 of FIG. 1 via the processing module 220 of FIG. 2.

If it is determined at 312 that a point of interest is not in proximity to the vehicle (or, in one embodiment discussed above, whether a categorizable point of interest is in proximity to the vehicle), then one or more vehicle actions are identified at 314. Specifically, in certain embodiments, an identification is made as to one or more settings that are currently in effect for operation of the vehicle 100 for one or more operational systems 114 and/or for the drive system 110. For example, in certain embodiments, the settings may comprise one or more of the following: an adjustable ride height for the vehicle 100, one or more performing modes for the vehicle 100 (e.g., a tour mode versus a sport mode, a performing mode versus a quiet mode, a standard mode versus an off road, and so on), one or more settings for steering, stability control, braking, suspension, shock absorbers, exhaust control, noise control, and/or one or more of a number of different types of vehicle operational settings. In certain embodiments, the vehicle actions (e.g., settings) are identified by the processor 142 of FIG. 1 and/or the processing module 220 of FIG. 2 based on commands received from an operator of the vehicle 100 and/or a known state of the drive system 110 and/or one or more operational systems 114, for example, as relayed from the drive system 110 and/or the operational systems 114 to the processor 142 via the communication link 116. In certain other embodiments, the vehicle actions (e.g., settings) are identified by the processor 142 of FIG. 1 and/or the processing module 220 of FIG. 2 based on sensor data received from vehicle sensors 136 of the sensor array 126.

In certain embodiments, a first notice is provided to the operator at 316, based on the identification of the vehicle action at 314. Specifically, in certain embodiments, the processor 142 of FIG. 1 and/or the processing module 220 of FIG. 2 provide instructions for the display 124 of FIG. 1 to provide a visual and/or audio notification of the detected vehicle action of 314, along with an inquiry as to whether the operator would like the current vehicle action (e.g., setting) to be automatically repeated in subsequent vehicle drives in which the vehicle 100 encounters the same location identified at 310. In various embodiments, the input sensors 134 of FIG. 1 receive corresponding inputs from the operator as to the operator's preferences and provide the inputs to the processor 142.

A determination is made at 318 as to whether the operator has indicated a preference to repeat the vehicle action (e.g., setting) when the vehicle 100 encounters the same location in the future. In various embodiments, this determination is made by the processor 142 of FIG. 1 and/or the processing module 220 of FIG. 2 based on the inputs obtained at 316.

In various embodiments, if it is determined at 318 that the operator has indicated a preference to repeat the vehicle action (e.g., setting) when the vehicle 100 encounters the same location in the future, then the identified location of 310 and the identified action of 314 are stored together in memory at 322. In various embodiments, the identified location and the identified action are stored together in the memory 144 of FIG. 1 as stored values 154 thereof, so that the vehicle action (e.g., setting) of 314 may be automatically repeated in the future when the vehicle 100 is again in proximity to the same location of 310. In various embodiments, the process then proceeds to step 338, described further below.

Conversely, also in various embodiments, if it is determined at 318 that the operator has not indicated a preference to repeat the vehicle action (e.g., setting) when the vehicle 100 encounters the same location in the future, then the process proceeds instead to 320. During 320, no action is taken. For example, the location and vehicle action are not stored in memory. In various embodiments, the process then proceeds to step 338, described further below.

With reference back to 312, if it is instead determined at 312 that a point of interest is in proximity to the vehicle, then an identification is made at 323 as to a category to which the point of interest belongs. In various embodiments, the category pertains to an identifiable characteristic of the point of interest that relates the point of interest with other points of interest that also belong to the same category. In certain embodiments, a point of interest category may pertain to the terrain associated with the point of interest (e.g., smooth surface versus off-road surface, and so on). Also in certain embodiments, a point of interest category may pertain to a type of area surrounding the point of interest (e.g., a residential neighborhood versus an open road versus a business district, and so on). Also in certain embodiments, a point of interest category may pertain to a type of service offered at the point of interest (e.g., education services for schools, medical care for hospitals, dining services for restaurants, retail services for stores, gasoline or repair work for service stations, lodging for hotels, sight-seeing for scenic destinations, and so on). In various embodiments, the identification of the category is made by the processor 142 and/or the processing module 220 of FIG. 2.

A determination is made at 324 as to whether the category of 323 is stored (or registered) in memory as being associated with a particular vehicle action (e.g., setting). In certain embodiments, a determination is made as to whether the category of 323 already has one or more pre-set values stored in the memory of the vehicle 100 for one or more settings for operational features of the vehicle 100 for when the vehicle 100 approaches a point of interest in the identified category. For example, in one embodiment, if the vehicle 100 is in proximity to a hospital, then a determination is made at 324 as to whether any pre-set values are stored in memory for vehicle settings for when the vehicle 100 approaches a hospital, and so on.

If it is determined at 324 that the category is not stored in memory as being associated with a particular vehicle action, then the process proceeds to 326. During 326, an identification is made as to one or more vehicle actions (e.g., settings) that are currently in effect for operation of the vehicle 100 (similar to step 314, described above).

In certain embodiments, a second notice is provided to the operator at 328, based on the identification of the vehicle action at 326. Specifically, in certain embodiments, the processor 142 of FIG. 1 and/or the processing module 220 of FIG. 2 provide instructions for the display 124 of FIG. 1 to provide a visual and/or audio notification of the detected vehicle action (e.g., setting), along with an inquiry as to whether the operator would like the current vehicle action (e.g., setting) to be (i) automatically repeated in subsequent vehicle drives in which the vehicle 100 encounters the same location identified at 310, but only for this particular location; (ii) automatically repeated in subsequent vehicle drives in which the vehicle 100 encounters the same location identified at 310 or any other point of interest of the same category identified at 323; or (iii) not automatically repeated. In various embodiments, the input sensors 134 of FIG. 1 receive corresponding inputs from the operator and provide the inputs to the processor 142.

A determination is made at 330 as to which of the preferences (from above) have been expressed by the operator. In various embodiments, this determination is made by the processor 142 of FIG. 1 and/or the processing module 220 of FIG. 2 based on the inputs obtained at 328.

In various embodiments, if it is determined at 330 that the operator has indicated a preference to repeat the vehicle action (e.g., setting) when the vehicle 100 encounters the same location in the future, but only for this particular location, then then the process proceeds to the above-referenced step 322, as the identified location of 310 and the identified action (e.g., setting) of 326 are stored together in memory, so that the vehicle action (e.g., setting) of 326 may be automatically repeated subsequently when the vehicle 100 is again in proximity to the same location of 310 (for example, in future drive cycles). In various embodiments, the process then proceeds to step 338, described further below.

Also in various embodiments, if it is determined at 330 that the operator has indicated a preference to repeat the vehicle action (e.g., setting) whenever the vehicle 100 encounters a point of interest of the same category as the category of step 323, then the process proceeds instead to step 334. During step 334, the identified point of interest category of step 323 and the identified action (e.g., setting) of 326 are stored together in memory (e.g., as stored values 154 of the memory 144 of FIG. 1), so that the vehicle action (e.g., setting) of 326 may be automatically repeated subsequently when the vehicle 100 is again in proximity to a point of interest of the same category as the category identified in step 323 (e.g., subsequently in the same drive cycle, or in future drive cycles). In various embodiments, the process then proceeds to step 338, described further below.

Also in various embodiments, if it is determined at 330 that the operator has not indicated a preference to repeat the vehicle action (e.g., setting) when the vehicle 100 encounters the same location or category in the future, then the process proceeds instead to the above-referenced 320, as no action is taken. In various embodiments, the process then proceeds to step 338, described further below.

Returning back to 324, if it is determined instead that the category is stored in memory as being associated with a particular vehicle action, then the process proceeds instead to 336. During 336, the vehicle action associated with the category of 323 is implemented. In various embodiments, pre-set values for one or more vehicle operational settings associated with the identified point of interest category are implemented at 336. Also in various embodiments, the pre-set values would have previously been stored together in memory along with the point of interest category in a previous iteration of step 330, and are now implemented together again in a current iteration of step 336. Also in various embodiments, the processor 142 of FIG. 1 and/or the processing module 220 of FIG. 2 provide instructions to one or more vehicle systems (such as the drive system and/or more operational systems 114 of FIG. 1) to implement the pre-set values for operational features of the vehicle 100 that are controlled by the respective vehicle systems. For example, in certain embodiments, if a pre-set value for a lowered ride height was stored in memory as associated with the current category of point of interest, then the ride height would now be automatically lowered to the pre-set value, and so on. Also in various embodiments, the process proceeds to step 338, described directly below. Also in certain embodiments, during step 336, an inquiry is made (e.g., by the processor 142 of FIG. 1 and/or the processing module 220 of FIG. 2) as to whether the driver wishes for the action to proceed.

In various embodiments, during step 338, a determination is made as to whether the process is to continue. In certain embodiments, this determination is made by the processor 142 of FIG. 1 and/or the processing module 220 of FIG. 2, for example based on whether the vehicle 100 is continuing to travel during the current vehicle drive, with the point of interest functionality of step 304 remaining enabled. In various embodiments, if the determination is for the process to continue, then the process returns to the above-described step 306, in a new iteration. Otherwise, in various embodiments, the process terminates at 340.

Accordingly, methods, systems, and vehicles are provided for automatic implementation of settings for operational features of a vehicle based on points of interest that may be in proximity to the vehicle. In various embodiments, one or more settings of operational features of the vehicle are automatically implemented when the vehicle is in proximity to a particular category of point of interest. For example, in certain embodiments, when an operator has indicated a preference (based on user inputs and prior user activity) to lower the ride height when the vehicle is in proximity to a school (e.g., to allow children to easily enter or exit from the vehicle), then the vehicle will automatically adjust the ride height in a similar manner when approaching the same or other schools. By way of additional example, in certain embodiments, when an operator has indicated a preference (based on user inputs and prior user activity) to adjust exhaust functionality of the vehicle to reduce sound when the vehicle is in proximity to a residential neighborhood (e.g., so as not to disturb residents), then the vehicle will automatically adjust the exhaust functionality in a similar manner when approaching the same or other neighborhoods. By way of further example, in certain embodiments, when an operator has indicated a preference (based on user inputs and prior user activity) to adjust a suspension of the vehicle to an off-road mode when the vehicle is in proximity to a rocky and/or uneven terrain, then the vehicle will automatically adjust the suspension in a similar manner when approaching the same location and/or one or more other locations with a similar terrain, and so on.

It will be appreciated that the systems, vehicles, and methods may vary from those depicted in the Figures and described herein. For example, the vehicle 100, the control system 102, and/or components thereof of FIGS. 1 and 2 may vary in different embodiments. It will similarly be appreciated that the steps of the process 300 may differ from those depicted in FIG. 3, and/or that various steps of the process 300 may occur concurrently and/or in a different order than that depicted in FIG. 3.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
identifying a point of interest in proximity to a vehicle based on location data for the vehicle;
determining a category to which the point of interest belongs; and
initiating, via instructions provided by a processor, a setting for a feature for operation of the vehicle based on the category for the point of interest that is in proximity to the vehicle and a history of the vehicle.

2. The method of claim 1, wherein the step of initiating the setting comprises:
initiating a pre-set value for ride height of the vehicle, based on the category for the point of interest that is in proximity to the vehicle and the history of the vehicle.

3. The method of claim 1, wherein the step of initiating the setting comprises:
initiating a pre-set value for a performing mode of the vehicle, based on the category for the point of interest that is in proximity to the vehicle and the history of the vehicle.

4. The method of claim 1, wherein the category comprises a type of terrain associated with the point of interest that is in proximity to the vehicle.

5. The method of claim 1, wherein the category comprises a type of service provided at the point of interest that is in proximity to the vehicle.

6. The method of claim 1, further comprising:
identifying an action for the vehicle while the vehicle is in proximity to the point of interest, based on vehicle data; and
storing, in memory, a pre-set value for the feature for the category for the point of interest that is in proximity to the vehicle, based on the identified action.

7. The method of claim 6, further comprising:
receiving an input from a user of the vehicle as to whether the action should be replicated when the vehicle is in proximity to similar points of interest at future times;
wherein the pre-set value is stored in the memory for the setting for the feature for the category for the point of interest that is proximity to the vehicle, based on the identified action, upon a further condition that the input from the user provides that the action should be replicated when the vehicle is in proximity to similar points of interest at future times.

8. The method of claim 6, wherein the vehicle data pertains to an operator command for a vehicle system associated with the action.

9. The method of claim 6, wherein the vehicle data pertains to sensor data for operation of a vehicle system associated with the action.

10. The method of claim 1, further comprising:
determining whether the category of the point of interest that is in proximity to the vehicle has a pre-set value stored in a memory of the vehicle for the feature;
wherein the step of initiating the setting comprises initiating, via instructions provided by the processor, the pre-set value for the feature when the pre-set value is stored in the memory.

11. A system comprising:
a data module configured to obtain location data pertaining to a vehicle; and
a processing module coupled to the data module and configured to, using a processor:
identify a point of interest in proximity to the vehicle based on the location data;
determine a category to which the point of interest belongs; and
provide instructions to initiate a setting for a feature for operation of the vehicle based on the category for the point of interest that is in proximity to the vehicle and a history of the vehicle.

12. The system of claim 11, wherein:
the data module is further configured to obtain vehicle data for the vehicle; and
the processing module is configured to:
identify an action for the vehicle while the vehicle is in proximity to the point of interest, based on the vehicle data; and
store, in memory, a pre-set value for the feature for the category for the point of interest that is in proximity to the vehicle, based on the identified action.

13. The system of claim 12, wherein:
the data module is further configured to receive an input from a user of the vehicle as to whether the action should be replicated when the vehicle is in proximity to similar points of interest at future times; and
the processing module is configured to store the pre-set value in the memory for the setting for the feature for the category for the point of interest that is proximity to the vehicle, based on the identified action, upon a further condition that the input from the user provides that the action should be replicated when the vehicle is in proximity to similar points of interest at future times.

14. The system of claim 11, wherein the processing module is further configured to:
determine whether the category of the point of interest that is in proximity to the vehicle has a pre-set value stored in a memory of the vehicle for the feature; and
initiate, via instructions provided by the processor, the pre-set value for the feature when the pre-set value is stored in the memory.

15. A vehicle comprising:
a location system configured to obtain location data pertaining to the vehicle;
an operation system configured to provide a feature for operation of the vehicle; and
a processor coupled to the location system and the operation system, and configured to:
identify a point of interest in proximity to the vehicle based on the location data;
determine a category to which the point of interest belongs; and
provide instructions for the operation system to initiate a setting for the feature for operation of the vehicle based on the category for the point of interest that is in proximity to the vehicle and a history of the vehicle.

16. The vehicle of claim 15, wherein the processor is configured to provide instructions for the operation system to initiate a pre-set value for a ride height of the vehicle, based on the category for the point of interest that is in proximity to the vehicle and the history of the vehicle.

17. The vehicle of claim 15, wherein the processor is configured to provide instructions for the operation system to initiate a pre-set value for a performing mode of the vehicle, based on the category for the point of interest that is in proximity to the vehicle and the history of the vehicle.

18. The vehicle of claim 15, further comprising:
a memory;
wherein the processor is configured to:
identify an action for the vehicle while the vehicle is in proximity to the point of interest, based on vehicle data; and
store, in the memory, a pre-set value for the setting for the feature for the category for the point of interest that is in proximity to the vehicle, based on the identified action.

19. The vehicle of claim 18, further comprising:
a sensor configured to receive an input from a user of the vehicle as to whether the action should be replicated when the vehicle is in proximity to similar points of interest at future times;
wherein the processor is configured to store the pre-set value in the memory for the setting for the feature for the category for the point of interest that is proximity to the vehicle, based on the identified action, upon a further condition that the input from the user provides that the action should be replicated when the vehicle is in proximity to similar points of interest at future times.

20. The vehicle of claim 15, further comprising:
a memory;
wherein the processor is configured to:
determine whether the category of the point of interest that is in proximity to the vehicle has a pre-set value stored in the memory for the feature; and
provide instructions to the operation system to initiate the pre-set value for the feature when the pre-set value is stored in the memory.
